(19) United States
(12) Patent Application Publication
(10) Pub. No.: US 2025/0057359 A1
(43) Pub. Date: Feb. 20, 2025

(54) DEVICE AND METHOD FOR AUTOMATIC PREPARATION AND DISPENSING OF HOT DOGS

(71) Applicants: Marcin Wojtys, Warsaw (PL); Grzegorz Gromacki, Poznan (PL); Damian Brylkowski, Swarzedz (PL)

(72) Inventors: Marcin Wojtys, Warsaw (PL); Grzegorz Gromacki, Poznan (PL); Damian Brylkowski, Swarzedz (PL)

(21) Appl. No.: 18/714,052

(22) PCT Filed: Dec. 6, 2022
(86) PCT No.: PCT/IB2022/061833

§ 371 Date: May 28, 2024

(30) Foreign Application Priority Data
Dec. 6, 2021 (PL) P.439755

(51) Int. Cl. A47J 37/08; A47J 37/04; G07F 17/00

(52) U.S. Cl. CPC A47J 37/0864; A47J 37/048; G07F 17/0078

(57) ABSTRACT

A device and a method for the automatic preparation and dispensing of hot dogs comprising a housing fitted with a door, inside of which is a hot dog preparation system comprising a refrigeration unit, a gripper, a drive system, a controller, a toaster system and a sauce application mechanism, together with a self-cleaning system, characterised in that a control panel is located on the outside of the housing, a hot dog pick-up point is located in the housing, constituting a link between the external part and the interior of the housing, and inside the housing there is a refrigerating unit containing storage for the buns and the food input in the form of drawers with closing mechanism that are opened and closed by a dedicated manipulator in response to an order signal received by the controller, the toaster system comprising a dedicated toaster for the food input and a mobile toaster for the buns, wherein the dedicated food input toaster is equipped with rollers containing patron heaters and an infrared radiator, while the mobile bun toaster is equipped with a housing with a lockable lid, heating elements in the form of patron heaters arranged around the plates, while the sauce application mechanism comprises at least one sauce container, at least one movable sauce application nozzle and at least one sauce pump.

The subject-matter of the invention is a device and a method for automatic preparation and dispensing of hot dogs.

Manual devices for preparing hot dogs are known from the state of the art. For example, utility model CN206252376 U relates to a hot dog baking machine with a protective cover, which comprises a workbench, a hot dog sausage warming unit and a bread warming unit, with a steamer aperture on the workbench. The hot dog sausage warming device comprises a hot plate positioned in the steamer aperture, a steaming vessel positioned on the hot plate and a lid positioned on the steamer, with a top lid a bottomless glass jug. Whereby, the steaming vessel is equipped with a sieve and the bottomless glass jug is equipped with a round steaming basket. On the other hand, the bread warming unit comprises a glass shade and a heating unit housed in the glass shade. The heating unit includes a pointed-bar group seal and a heating sheet for heating the pointed-bar group seal.

Patent KR101834226 Bi discloses a hot dog cooking device comprising a main body with a heater integrated inside; a condiment unit detachably attached to the main body in the form of a drawer, storing and heating the condiment ingredients inside; a hot air cooking unit integrally located on the main body for cooking the ingredients using hot air; and a control unit for controlling the main body, the condiment unit and the hot air cooking unit.

In addition, automated systems for the preparation of hot dogs are known from the state of the art. For example, utility model CN207792044 U discloses an automatic hot dog making device contained in a transparent glass housing, equipped with a dynamic trolley, a mobile workbench, a bread rack, a sauce spraying and clamping mechanism and a sausage roasting machine; a gripper, a rear lid and its synchronous drive mechanism are fitted to the rear of the appliance. The condiment is characterised by the fact that each process in it is connected in series by a dynamic trolley and the dynamic trolley moves in a circular motion along a fixed track to transport the mobile working bench to the different positions of the entire appliance.

On the other hand, application U.S. Pat. No. 3,548,738 A relates to a coin-operated hot dog vending machine, which is provided with a food cabinet having a food delivery aperture that delivers cartons containing hot dogs in response to the insertion of coins into said vending machine, and a food cooking chamber located in said cabinet and receiving said cartons delivered in the food delivery aperture. Whereby, said food cooking chamber comprises a pair of arranged receiving actuating rods and a defined division between the rods which are actuated by an electrical supply circuit. Whereby, the disclosed hot dog vending machine comprises a food cooking zone comprising a recessed chamber and a pair of spaced apart horizontal actuating rods. An openable door that covers the chamber can be provided with a glass panel when desired so that the purchaser can observe the cooking operations. The vending machine also includes a refrigerated food storage compartment (not shown in the figure) for use by the vending machine operator. It is anticipated that the vending machine operator will periodically service the vending machine to deliver packets of fresh food and remove coins deposited during vending machine operations. Packets of food stored in the refrigerated storage compartment are delivered one at a time through the food delivery aperture in response to the coin vending machine operation in any well-known conventional manner. A manual timer sets the top of the front of the machine at a conventional height to allow the hot dog purchaser to operate the cooking circuit ready. A manual timer switch connects in series with the circuit to provide a time interval for electricity to be supplied to the actuating rods for the purpose of cooking the hot dogs. A bull's-eye indicator light is fitted to the front of the cabinet and connects in series with the circuit to give a visual indication of the duration of the cooking cycle. The actuating rods are spaced an equivalent distance apart to the length of the carton containing the hot dog, and the hot dog actually completes the electrical circuit between the actuating rods. The flow of electrical current through the hot dog 36 actually completes the electrical circuit between the actuating rods. To operate the vending machine, a coin is inserted into the slider and the slider is pushed backwards into the vending machine. In this way, one carton containing a hot dog will automatically be delivered through the food dispensing aperture in the well-known manner. The purchaser then opens the door and places the carton between the actuating bars. The electrodes overlap the lower points of the folded ends of the carton and thus make appropriate contact with the actuating rod part of the surfaces along the entire length of the electrode tabs. The cardboard box can be placed between the electrodes by inserting the cardboard into the space between the end of the actuating rod and the edge of the chamber, and then sliding the cardboard transversely along the actuating rods. If it is desired to cook more than one hot dog at a time, the carton can be moved further along the bars until sufficient space is provided for all the desired cartons.

The hot dog preparation systems available in the state of the art must therefore be considered semi-automatic, since the assistance of a human operator is necessary during the preparation process.

The purpose of the invention is to provide a device and a method for preparing and dispensing hot dogs that minimises the involvement of the human factor understood to be only the ordering of the hot dog or the maintenance activities (i.e. replenishment of food products, cleaning and repair of the device).

The essence of the invention is a device for the automatic preparation and dispensing of hot dogs comprising a housing fitted with a door, inside of which is a hot dog preparation system comprising a refrigeration unit, a gripper, a drive system, a controller, a toaster system and a sauce application mechanism, together with a self-cleaning system, characterised in that a control panel is located on the outside of the housing, a hot dog pick-up point is located in the housing, constituting a link between the external part and the interior of the housing, and inside the housing there is a refrigerating unit containing storage for the buns and the food input in the form of drawers with closing mechanism that are opened and closed by a dedicated manipulator in response to an order signal received by the controller, the toaster system comprising a dedicated toaster for the food input and a mobile toaster for the buns, wherein the dedicated food input toaster is equipped with rollers containing patron heaters and an infrared radiator, while the mobile bun toaster is equipped with a housing with a lockable lid, heating elements in the form of patron heaters arranged around the plates, while the sauce application mechanism comprises at least one sauce container, at least one movable sauce application nozzle and at least one sauce pump.

Advantageously, the hot dog pick-up point consists of a feeder equipped with movable bulkheads separating the external environment from the interior of the appliance.

Advantageously, the drawers of the refrigeration unit are provided with profiled positioning points.

Advantageously, the appliance in accordance with the invention is equipped with a product presence detector located on the gripper or in the refrigeration unit.

Advantageously, the fronts of the pull-out drawers constitute the door of the refrigeration unit.

Advantageously, the refrigeration unit is selected from the group comprising a refrigerator, a refrigerator-freezer or a freezer.

Advantageously, the toaster dedicated to the food input is provided with a pusher.

Advantageously, the control panel can communicate with an external system selected from the group consisting of a mobile application, a cash register system or a combination thereof.

Advantageously, the device in accordance with the invention is provided with a dispensing mechanism for dispensing napkins to a rotating hot dog pick-up point.

Advantageously, the infrared radiator is selected from the group consisting of a quartz radiator or a ceramic radiator.

Advantageously, the infrared radiator is mounted on a movable axis.

Advantageously, the sauce application mechanism comprises from 1 to 5 sauce application nozzles.

Another subject-matter of the invention is a method for the automatic preparation and dispensing of hot dogs by an appliance in accordance with the invention, characterised in that it comprises the following steps:
a) starting the hot dog preparation process after the product has been selected and paid for by the user;
b) transmission of a signal to the controller initiating the opening of the drawer of the refrigeration unit by means of a dedicated manipulator;
c) picking up the food input and the bun by the gripper from the currently extended drawer of the refrigeration unit;
d) the food portion being simultaneously conveyed by the gripper to the sausage toaster and the bun to the bun toaster;
e) the gripper dropping the food input onto the dedicated sausage toaster and the bun onto the bun toaster in the toasting positions;
f) heating of the food input by activating the rotary rollers with the internal heaters of the toaster dedicated to the food inputs and lowering the infrared radiator, and toasting of the bun by means of heaters arranged around the plates of the bun toaster which, during toasting of the bun, is set in a horizontal position and then in a vertical position, while heating of the food input and toasting of the bun take place simultaneously;
g) when the food input and the bun have reached the desired temperature, the heating elements of the food input toaster and the bun toaster switch off,
h) positioning of at least one nozzle and application of the sauce by at least one application nozzle of the sauce application mechanism to the toasted bun situated within the bun toaster, which, during this operation, is in a vertical position;
i) aligning the centre line of the food input and the bun in the toaster by returning the bun toaster to the horizontal position and inserting the food input into the bun using the movable pusher and cleanser while cleaning the toaster elements dedicated to the food input;
j) lifting the top lid of the bun toaster and the gripper picking up the hot dog;
k) having a napkin placed in the hot dog pick-up area by the napkin dispensing and delivery mechanism;
l) having the hot dog transferred to the hot dog pick-up point;
m) dispensing the hot dog to the customer from the hot dog pick-up point.

Advantageously in step a), the payment is made via a control panel either via a dedicated application or via the cash register system of the facility using the appliance in accordance with the invention.

Advantageously, the hot dog pick-up point consists of a feeder equipped with movable bulkheads, and in step m) the dispensing of the hot dog is performed by rotating the dispensing feeder.

The invention provides the following advantages:
minimises the human factor, which is epidemiologically important, especially in the era of the Sars-Cov-2 pandemic;
the invention provides stricter hygiene in hot dog preparation—the number of people touching the food is reduced to a minimum;
employee involvement is minimised to refilling sausage, buns and sauces, washing and servicing the unit;
automatic operation of the unit will increase the efficiency of customer service;
the built-in refrigerator ensures the freshness of semi-finished products and reduces product waste (no need to warm up products until they are ordered);
in accordance with the invention, the appliance can be placed outside the shop or bar, as well as at mass events, petrol stations, in particular those having charging stations for electric cars;
the appliance can be used inside self-service shops.

The subject-matter of the invention is depicted in the embodiments shown in the drawing, wherein:

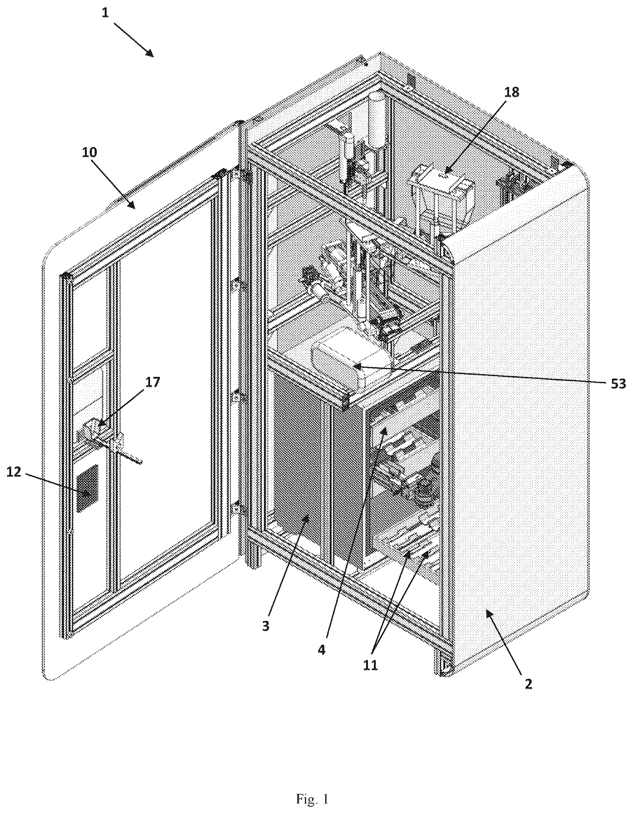

FIG. 1 shows the device in accordance with the invention in an overview view;

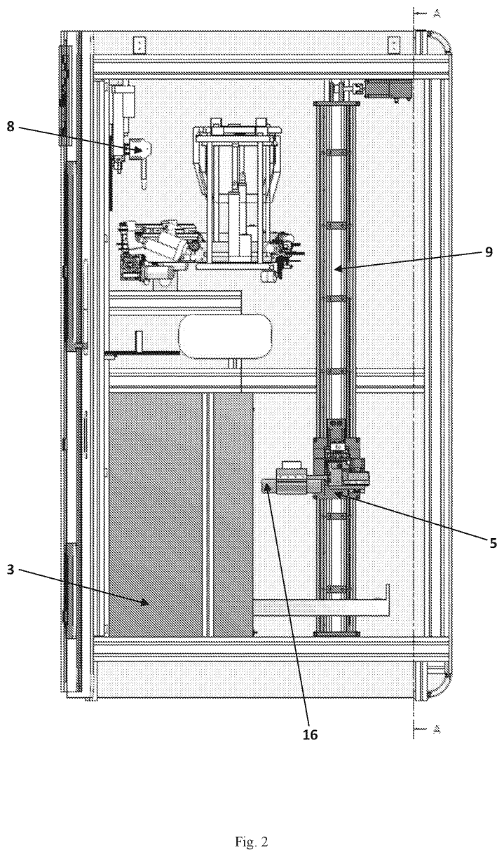

FIG. 2 shows the interior of the device in accordance with the invention in front view;

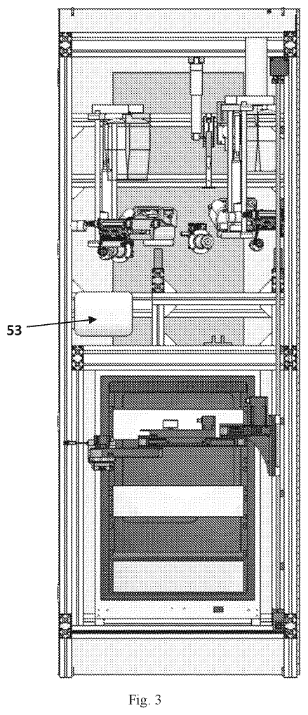

FIG. 3 shows the interior of the device in accordance with the invention of FIG. 2 in cross-section A-A;

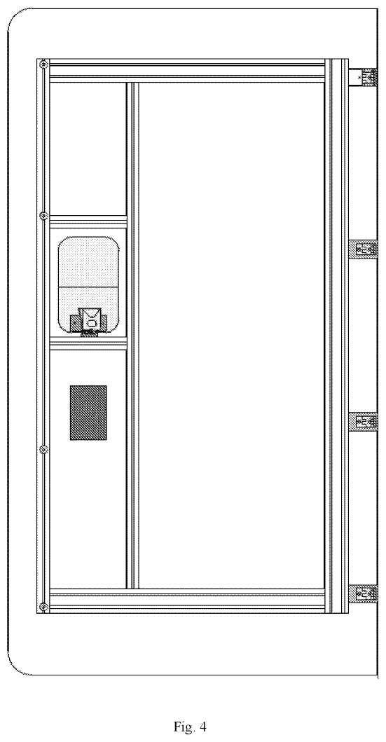

FIG. 4 shows the door of the housing of the device in accordance with the invention as seen from the inside of the machine;

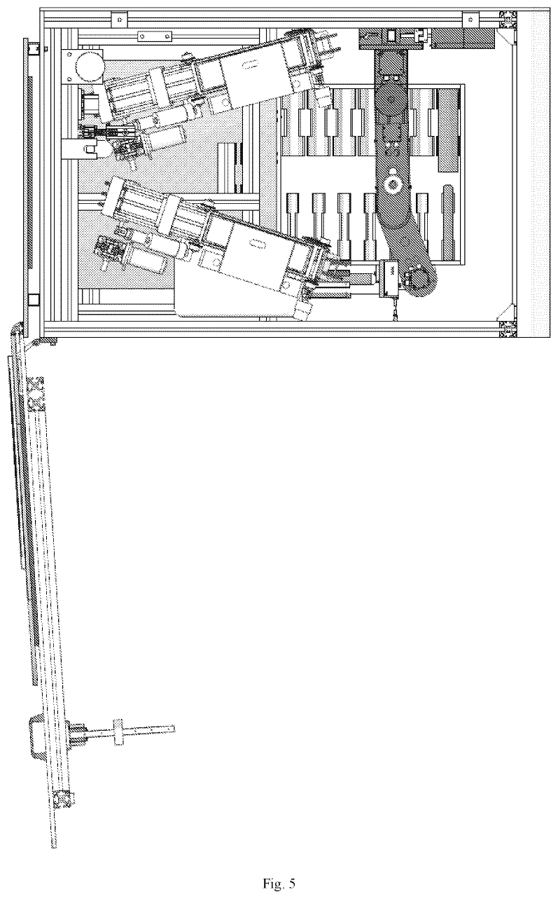

FIG. 5 shows the interior of the housing of the device in accordance with the invention in the top view;

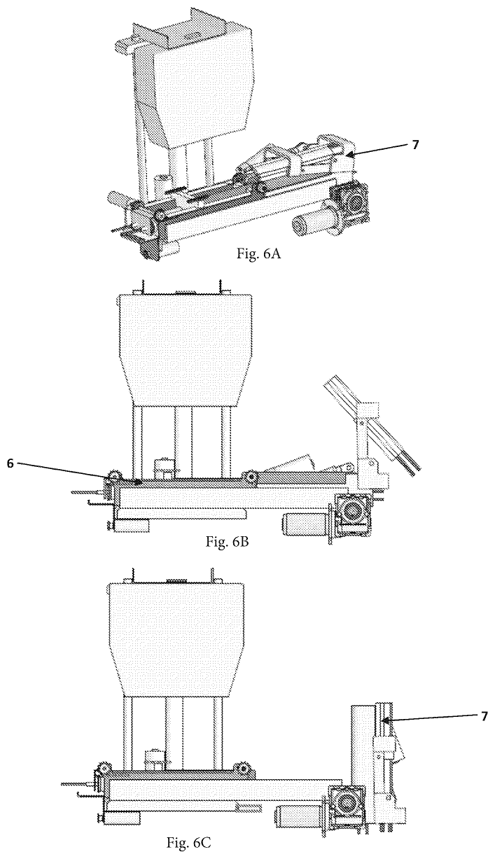

FIG. 6 shows the structure of a radiator with a section of a sausage-dedicated toaster and bun toaster, where A) shows the said system in an overview view, B) shows the said system with the bun toaster set in the position ready for the gripper to deposit the food, C) shows the said system with the bun toaster set in the position ready to apply the sauce;

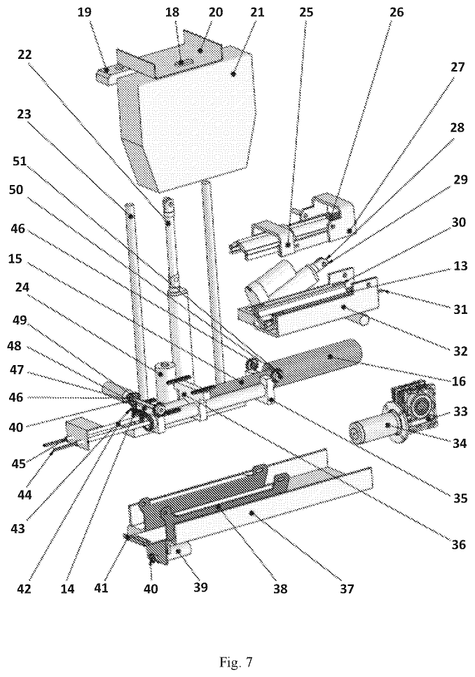

FIG. 7 shows the detailed characteristics of the system of FIG. 6;

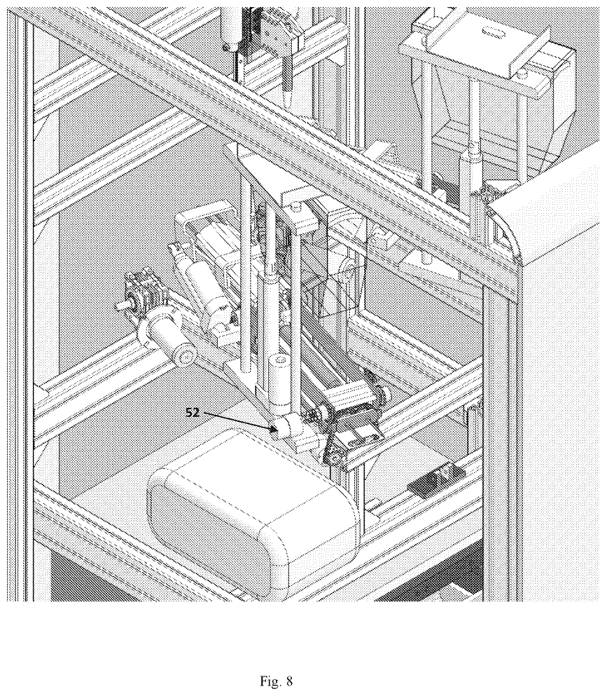

FIG. 8 shows the toasting system in the appliance in accordance with the invention in an overview view;

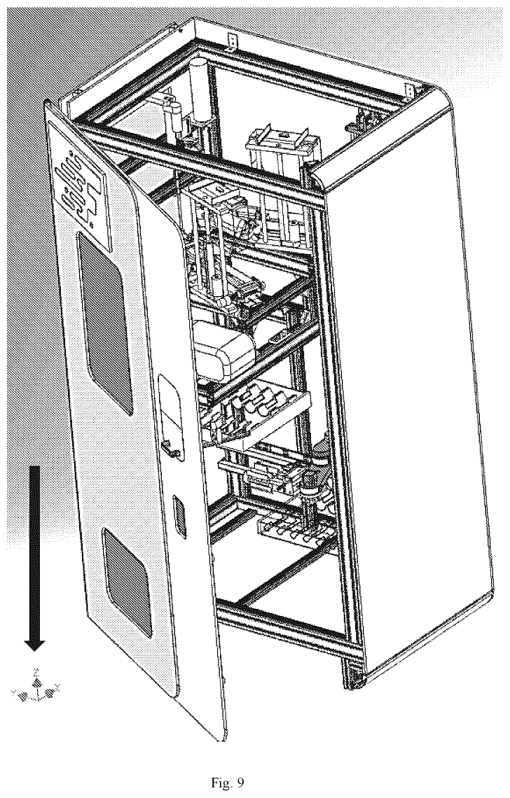

FIG. 9 shows the appliance in accordance with the invention with particular reference to the outside of the door.

### EXAMPLE 1

The device according to the invention is illustrated in the figure, where 1—denotes the device according to the invention; 2—denotes the housing; 3—denotes the refrigerating unit; 4—denotes the drawer; 5—denotes the gripper; 6—denotes the dedicated toaster for food input; 7 denotes the bun toaster; 8—denotes sauce application mechanism; 9—denotes gripper rail; 10—denotes door; 11—denotes positioning areas; 12—denotes control panel; 13—is the bun toaster plate; 14—is the toasting/rotating roller for the food input; 15—is the food input 16—is the bun; 17—denotes the hot dog pick-up point; 18—denotes the infrared radiator; 19—is the movable piston rod mounting bar and guides; 20—denotes the radiator housing mount; 21—is the radiator housing; 22—denotes the actuator piston rod; 23—denotes the radiator guide; 24—denotes the electric actuator of the radiator; 25—denotes the arm mountings; 26—denotes the arm for lifting the upper bun toasting plate; 27—denotes the rotating element for lifting the upper bun toasting plate; 28—denotes the piston rod of the bun toaster actuator; 29—is the electric cylinder of the bun toaster; 30—denotes the heater fixing to the plate that toasts the bun; 31—is the patron heater of the bun toaster; 32—denotes the rotating element of the bun toaster; 33—is the gearbox; 34—denotes the worm gear motor; 35—denotes the Teflon roller bearing; 36—denotes the Teflon sausage pusher and roller cleaner; 37—is the fixing base; 38—denotes the roller trough; 39—denotes the toasting roller motor; 40—is the gear wheel; 41—denotes the removable tray underneath the rollers; 42—is the fixing bar for the guides and the radiator actuator; 43—denotes the chain; 44—is the patron heater of the roller toaster; 45—denotes the heater fixing element; 46—is the washer; 47—denotes the slide bearing; 48—denotes the Teflon roller bearing element; 49—denotes the scraper drive shaft; 50—is the hexagon socket tooth fit screws; 51—is the nut; 52—drives the mechanism that places the sausage in the bun; 53—is the napkin dispenser; and Z is the movable axle.

Whereby, within the meaning of the invention, the food input 15 may be a sausage (e.g. poultry, pork, veal), sausage, cabanos or so-called meatless sausages (vegetable or fish). In contrast, in this embodiment, the food input 15 is a sausage.

The device 1 for the automatic preparation and dispensing of hot dogs is schematically shown in FIG. 1-5. In this embodiment, the device 1 is connected to a standard 230V socket as a power source. Furthermore, the device 1 is additionally equipped with a UPS (battery+inverter) to maintain the “numerical information” about the current position of the drives and the process, as well as to supply the refrigeration unit 3.

Device 1 consists of a housing 2 equipped with a door 10, which, in the embodiment, is made of steel. The maintenance and the service and technical support of the appliance 1 (e.g. replenishment of the semi-finished products in the refrigeration unit 3) can be carried out after opening the front door 10 of the appliance 1. The interior of the housing comprises a refrigeration unit 3 to store the sausages 15 and buns 16 and a hot dog preparation system comprising a gripper 5 moving along a rail 9, a drive system, a controller, a toaster system and a sauce application mechanism 8.

Whereby, the drive system comprises:
Drives of the toaster system comprising: the rollers drive of the dedicated food input toaster 6; pusher drive 52; bun toaster drive 7—electric motors, radiator drive and bun toaster lid drive—electric actuators;
Dedicated manipulator for opening the drawers 4 of the refrigeration unit 3, which manipulator consists of two motors that move the manipulator arm that will open and close the respective drawer;
The gripper drive 5, which consists of four motors that move the arms. On the last drive of a gripper 5 there are two gripping tips installed. One of these gripping tips grips the food input 15 (e.g. a sausage) and the other a bun 16 or a hot dog (optionally also a napkin)—the movement of the jaws of the gripping tips is executed by way of an electric actuator or an electromagnet;
Drives for the sauce application mechanism 8, the number of which depends on the number of sauces (each sauce is put in a separate tank with a dedicated nozzle, a dedicated pump and a dedicated drive). Each of the sauce drives consists of a drive that activates the pump (electric motor) and drives that move the nozzle in two directions (electric actuators)—i.e. from the rest position to the position over the toasted bun 16 and back to the rest position.

Furthermore, in the event where the device 1 is provided with a napkin dispensing mechanism in the form of a napkin dispenser 53 connected to a dedicated gripping system located above said dispenser 53, said dedicated gripping system consists of a dedicated manipulator, wherein the movement of the jaws of the manipulator is carried out by means of an electric actuator or an electromagnet, and the movement of the manipulator with the retrieved napkin is carried out by means of an electric actuator.

A control panel 12 connected to the controller is mounted on the outer part of the door 10 of the housing 2. In this embodiment, the control panel 12 is wired to the controller. In this embodiment, the control panel 12 is an integrated tablet, which contains an interface for order selection and payment. In addition, the control panel 12 may be connected to an external system supporting alternative payment methods. Such an external system may be, for example, a dedicated mobile application installed on the customer's device or the checkout system of the shop where the device 1 is located. If the device 1 is connected to the checkout system, the order and the payment for the order can be processed at the cashier.

On the other hand, in this embodiment, the controller is an industrial PLC with expansion cards (inputs, outputs, drive operation, communication interfaces) and an HMI operating panel. In addition, the controller includes a relay equipped with communication means (e.g. Ethernet interface).

In this non-restrictive embodiment, the refrigeration unit 3 is a refrigerator. Alternatively, other appliances, e.g. a freezer or a fridge-freezer, may be used. The example refrigerator 3 is shown in detail in FIG. 1 and FIG. 3. The refrigerator 3 is provided with pull-out drawers 4 constituting storage compartments for food inputs 15 (e.g. sausages) and buns 16, which are stored in the positioning spaces 11. The said positioning spaces 11 are contoured spaces in the drawers 4 into which the device operator 1 will deposit the semi-finished products (i.e. the food input 15 and the buns 16) in order to replenish shortages.

In this embodiment there are three drawers 4 and the drawer fronts 4 also perform the function of doors of the refrigeration unit 3. Furthermore, in this non-limiting embodiment, the refrigerator 3 comprises a product presence detector wired to the controller, the locations to position 11 the semi-finished products (i.e. sausages 15 and buns 16) and a feeding system in the form of pull-out drawers 4 with a closing mechanism, which, for example, can be magnets. Furthermore, in this embodiment, a dedicated drawer opening manipulator 4 is provided for the refrigeration unit 3, which comprises two motors, which move the manipulator arm which will open and close the respective drawer 4.

After detecting the absence of a given semi-finished product in the drawer 4, the detector sends information to the controller, which sends the information to the control panel 12, which displays an appropriate message on the screen and generates an acoustic signal. Alternatively, if the device 1 is connected to a cash register system, the controller sends a signal (telegram) to the cash register.

In this embodiment, the gripper 5 is equipped with two pairs of jaws (separate for the sausage 15 and for the bun 16). The jaws are on a single axis and are characterised by a spacing enabling the simultaneous picking up and putting down of the bun 16 and the sausage 15. The movement of the jaws is executed by means of an electric gripper drive 5. A rail 9 of the gripper extends over the entire height of the appliance, which allows the gripper 5 to move between the refrigeration unit 3 and the toaster system located inside the device housing 1 above the refrigeration unit 3.

In this embodiment, the toaster system consists of a dedicated toaster for food inputs 6 and a toaster for buns 7. As shown in FIG. 6-8, in this embodiment the bun toaster 7 is provided with a housing with a lockable lid, heating elements in the form of patron heaters 31 placed around the toasting plates 13 and an electric drive, which allows for positioning the bun toaster 7 in an upright position, thus enabling application of the sauce to the toasted bun 16 through the sauce application mechanism 8 located above said bun toaster 7. In this embodiment, the electric drive of the bun toaster 7 consists of a monoreducer. However, other electric drives can be used, e.g. a linear actuator.

Furthermore, in this embodiment, the bun toaster 7 (i.e. on the plates 13) will comprise, on the inside, a pattern which will be baked on the bun 16. In this embodiment, the said pattern will be the wording “hot-dog”. On the other hand, the said pattern may feature any other inscription, logo or mark, etc.

In this embodiment, the sauce application mechanism 8 comprises five sauce tanks, five movable sauce application nozzles, five dedicated electric drives and five sauce pumps. In this embodiment, the sauce application mechanism is equipped with five nozzles, each of which is designated for a different sauce. Each nozzle is positioned over the bun 16 by means of a separate electric drive of the sauce application mechanism 8. Whereby, a separate tank and pump is designated for each sauce type. Furthermore, the sauce application mechanism 8 allows for different sauce packaging types (e.g. bag, bottle, pouch).

In this embodiment, the toaster dedicated to the food input 6 is equipped with two rollers rotating/toasting the sausage 14 (the rollers comprise patron heaters 44) and an infrared radiator 18, which in this embodiment is a ceramic infrared radiator mounted on a movable axis Z—i.e. along the height of the machine (the axes are indicated by an arrow in FIG. 9). However, a quartz radiator, for example, can also be used. An example of the structure of the radiator 18 and its installation in relation to the other components of the toaster system is shown in FIG. 6-8. As shown in FIG. 6-8, the toaster dedicated to the food input 6 and the bun toaster 7 are placed on a common base 37 ensuring that the toasters are properly positioned with respect to each other inside the appliance.

The toaster dedicated to the food input 6 comprises two rollers rotating/toasting 14 the food input 15, which in this embodiment is a sausage. Inside the said rollers 14 there are stationary heaters 44 which are fixed by means of a fastening element—a metal sheet having holes in which the heaters 44 are placed. The heaters 44 heat the rollers 14 which, together with the radiator 18, toast the sausage 15.

Underneath the rollers 14, a removable tray 41 is located to capture fat that may drip from the rollers 14 during the toasting of the sausage 15.

On the other hand, the radiator 18 as shown in FIG. 6-8 is housed in a housing 21 which, in this embodiment, is made of stainless steel polished to a high gloss. This allows it to reflect the infrared radiation and focus it on the food input 15 (e.g. a sausage), thus accelerating its heating.

Furthermore, in this embodiment, the mounting bar 42 for the guides and the actuator of the radiator is a piece of flat bar in which holes are made in which the aforementioned elements are placed. On the other hand, the guide 23 of the radiator 18 consists of ground rollers along which the movable bar 19 moves. The movement is executed by means of an electric actuator.

In addition, a hot-dog pick-up point 17 is located in the housing, providing a connection between the external surface and the interior of the housing 2.

Furthermore, in this embodiment, the toasting system of appliance 1 is provided with a pusher and a roller cleaner 36, the detailed structure of which is shown in FIG. 7.

In this embodiment, the pusher and the roller cleaner 36 (hereinafter referred to as pusher) is a Teflon-covered plate with the guide holes in which the rollers 14 are installed. While the sausage 15 (or other food input 15) is toasted, the holes serve as bearings for the rollers 14. When moving the sausage 15, the rollers 14 serve as a guide for the pusher 36. In addition, two threaded holes are made in element 36 to which chain is screwed by means of screws. The mechanism placing the sausage 15 in the bun 16 is driven by a motor 52 (FIG. 8), which is mounted along the axis of the shaft of the scraper's drive 49 and connected to the drive shaft mounted on the plain bearings 47 by means of a coupling, which transmits the rotational movement of the motor shaft to the drive shaft 49. Whereby, in this embodiment, drive shaft 49 is a steel shaft on which a pair of toothed wheels 40 are mounted. The function of the shaft is to transmit the rotational movement from the motor 52 to the toothed wheels 40.

As indicated above, a pair of toothed wheels 40 is installed on the shaft 49, while between the bearing 47 (e.g. a Teflon sleeve) and the toothed wheel 40 there are washers 46 which position the toothed wheels 40 on the shaft 49. The toothed wheels 40 are connected by a chain 43, which is connected to the sausage pusher 36. The role of the toothed wheels is to change the rotational motion (via the chain) coming from the motor 52—into a linear motion along the rollers 14. When the wheels 40 start to rotate, the chain 43 starts to move the pusher 36 along the rollers 14 seated in the bearings on the Teflon elements that bear rolls 35 and 48 of the roller. While the above-described elements make their path, pusher 36 pushes the sausage 15 into the bun 16. In addition, a second pair of toothed wheels 40 are also involved in the process, which are also mounted in bearing 47 and positioned by washers 46, which, in turn, are mounted to the roller troughs 38 by means of the slotted bolts 50 and nuts 51. Whereby, the role of said second pair of toothed wheels 40 is to tension the chain 43.

Furthermore, in this embodiment, the appliance 1 is provided with a dispensing mechanism for dispensing napkins into the rotating hot dog pick-up point 17. In this embodiment, the napkin dispensing mechanism is an electronic napkin dispenser 53 (e.g. the TORK XPRESS sensor napkin dispenser known from the state of the art), which stores napkins (or tissues or bags) and automatically issues one napkin for retrieval. The napkin dispenser 53 is connected to a dedicated gripping circuit located above said dispenser 53, which grabs this protruding single napkin (or tissue or paper bag) and moves it to the depositing location 17 of the finished hot dog.

As the hot dog falls, it wraps itself with the tissue, which prevents the hot dog from coming into direct contact with the rotating feeder of the appliance 1 (i.e. the hot dog pick-up point 17).

### EXAMPLE 2

Appliance as in embodiment 1 except that the sauce application mechanism 8 consists of a sauce tank, an electric drive, one movable nozzle and one pump. In addition, in this embodiment, the gripper 5 comprises a product presence detector. On the other hand, the hot dog pick-up point 17 is a rotating feeder equipped with movable bulkheads. In addition, in this embodiment, the napkin dispenser 53 does not comprise a dedicated gripping system, and the transfer of the napkin to the hot dog pick-up point 17 is realised by a gripper 5 equipped with two gripping tips located one below the other, of which the upper gripping tip picks up the finished hot dog, after which the gripper 5 moves over to the napkin dispenser 53, from which the lower gripping tip picks up the napkin. The gripper 5 then transports the hot hot-dog to the pick-up point 17, where it successively drops the napkin then the hot dog.

### EXAMPLE 3

The invention provides for automatic preparation and dispensing of hot dogs. In this embodiment, the method in accordance with the invention is embodied in device 1 in accordance with embodiment 2.

Whereby, within the meaning of the invention, the food input 15 may be a sausage (e.g. poultry, pork, veal), sausage, cabanos or so-called meatless sausages (vegetable or fish). In contrast, in this embodiment, the food input 15 is a sausage.

The process of automatic preparation and dispensing of the hot dogs starts with the selection of the desired product and payment through the control panel 12 of the device 1. Alternatively, payment can be made via a mobile application installed on the customer's device. Receipt and payment of the order generates a signal that is sent to the controller, which then initiates the process of preparing and dispensing the hot dog.

The controller initiates the opening of the drawer 4 of the refrigeration unit 3 by means of a dedicated manipulator 4, which consists of two motors that move the arm of the manipulator that will open and close the respective drawer 4. Then, the gripper 5 picks up a sausage 15 and a bun 16 from the currently extended drawer 4 of the refrigeration unit 3. Subsequently, the gripper 5 simultaneously transports the sausage 15 to the dedicated food input toaster 6 and the bun 16 to the bun toaster 7. The gripper 5 drops the sausage 15 onto the toaster dedicated to the food input 6 and the bun 16 onto the bun toaster 7 in the toasting positions. The next step is to heat the sausage 15 by activating the rotating rollers 14 with the internal heaters 44 of the toaster dedicated to the food input 6 and lowering the infrared radiator 18 to accelerate the heating process. Simultaneously, the buns 16 are toasted by means of heaters 31 arranged around the plates 13 of the bun toaster 7 which, during the toasting of the buns 16, is brought into a vertical position by means of a geared motor (or other electric drive) and a worm gear motor 34 which subsequently enables the application of sauce to the toasted bun 16.

Once the sausage 15 and the bun 16 have reached the pre-set temperature, the heating elements of the dedicated food input toaster 6 and the bun toaster 7 are switched off. Then, the application nozzle of the sauce application mechanism 8 is positioned over the bun 16 by means of a dedicated electronic drive and applies the sauce (e.g. mustard) to the bun 16 being toasted, located in the bun toaster 7 in a vertical position. The next step involves inserting the sausage into the bun using a movable pusher and cleaner 36 with the rollers 14 of the toaster 6 being simultaneously cleaned. At this stage, the axes of symmetry of the food input 15 (here sausages 15) and the buns 16 being toasted are aligned with each other in a single line. This makes it possible to slide the sausage 15 into the bun 16 just by moving (pushing) the sausage 15 along the rollers 14.

The alignment of the axis of symmetry of the sausage 15 and the bun 16 situated in the toasters is executed by means of the bun toaster 7 returning to the horizontal position.

The mechanism that places the sausage 15 in the bun 16 is driven by a motor 52 mounted along the axis of the shaft of the scraper's drive 49 and connected to the drive shaft mounted on the plain bearings 47 by means of a coupling, which transmits the rotational movement of the motor shaft to the drive shaft 49. A pair of toothed wheels 40 is installed on the shaft 49, while between the bearing 47 and the toothed wheel 40 there are washers 46 which position the toothed wheels 40 on the shaft 49. The toothed wheels 40 are connected by a chain 43, which is connected to the sausage pusher 36. When the wheels 40 start to rotate, the chain 43 starts to push the pusher 36 along the rollers 14 seated/mounted on the elements 35 and 48. While the above-described elements make their path, pusher 36 pushes the sausage 15 into the bun 16.

In addition, a second pair of toothed wheels 40 are also involved in the process, which are also mounted in bearing 47 and positioned by washers 46, The second pair of toothed wheels 40 is used to tension the chain 43 and is mounted to the roller trough 38 using the slotted bolts 50 and nuts 51. As a result of the operations, a hot dog ready for consumption is assembled. The next step is to lift the top lid of the bun toaster 7 and pick up the hot hot-dog through the gripper 5. This activates the napkin dispensing mechanism, which places a napkin at the hot dog pick-up point 17, before the hot dog is transferred to the pick-up point 17 by the gripper 5. The gripper 5 transfers the hot hot-dog to the pick-up point 17, which is a dispensing feeder with a pre-prepared napkin. After the hot dog is dropped by the gripper 5 onto the feeder 17, the hot dog is being dispensed to the customer by way of rotating the dispensing feeder 17.

### EXAMPLE 4

Method as in embodiment 3, except that device 1 is connected to the store's cash register system and the order and payment for the order can be processed at the cashier's.

### LIST OF DESIGNATIONS

1—device in accordance with the invention;
2—housing;
3—refrigeration unit;
4—drawer;
5—gripper;
6—toaster dedicated to the food input (e.g. sausages);
7—bun toaster;
8—sauce application mechanism;
9—grab rail
10—door
11—positioning areas
12—control panel
13—bun toaster plates
14—roller to toast/rotate the food input (e.g. sausage)
15—food input (e.g. sausage)
16—bun
17—hot-dog pick-up point
18—infrared radiator
19—movable bar to fasten the piston rod bar and guides
20—the mounting of the radiator housing
21—radiator housing
22—actuator's piston rod
23—radiator's guide
24—electric actuator for the radiator
25—arm mountings
26—arm for lifting the upper plate that toasts the bun
27—rotating element to lift the upper bun toasting plate
28—piston rod of the bun toast actuator
29—bun toaster electric actuator
30—mounting of the heaters mounting it to the bun toasting plate
31—bun toaster patron heater
32—rotating element of the bun toaster
33—gearbox
34—worm gear motor
35—teflon bearing of the rollers
36—teflon sausage pusher and roller cleaner
37—mounting base of toaster system
38—roller trough
39—dedicated toaster roller motor for sausages
40—toothed wheel
41—removable tray located under the rollers
42—fixing bar for the guides and toaster actuator
43—chain
44—patron heater of the roller toaster
45—heater fixing element
46—washer
47—slide bearing
48—teflon element mounting the rollers
49—scraper drive shaft
50—hexagon socket head cap screws
51—nut
52—motor for the mechanism that places the sausage in the bun
53—napkin dispenser
Z—movable axle

1. A device for automatic preparation and dispensing of French-style hot dogs comprising:
a housing fitted with a door,
a control panel is located on an outside of the housing;
a hot dog preparation system located inside the housing, comprising
a refrigeration unit,
a gripper,
a drive system,
a controller,
a toaster system, and
a sauce application mechanism, together with a self-cleaning system, a, a hot dog pick-up point is located in the housing, constituting a link between external part and interior of the housing, and inside the housing there is the refrigerating unit containing storage for buns and food input in form of drawers with a closing mechanism operated by a dedicated manipulator in response to an order signal received by the controller, the toaster system comprising a dedicated toaster for the food input and a moveable bun toaster, wherein the dedicated food input toaster is equipped with rollers containing cartridge heaters and an infrared radiator, wherein the toaster dedicated to the food input is provided with a pusher, while a mobile bun toaster is equipped with a housing with a lockable lid, heating elements in the form of cartridge heaters arranged around plates, while the sauce application mechanism comprises at least one sauce container, at least one movable sauce application nozzle and at least one sauce pump.

2. The device according to claim 1, wherein the hot dog pick-up point consists of a feeder equipped with vertically movable partitions separating an external environment from the interior of the unit.

3. The device according to claim 1, wherein the drawers of the refrigerating unit are provided with contoured positioning spaces.

4. The device according to claim 1, further comprising a product presence detector located either on the gripper or in the refrigerating unit.

5. The device according to claim 1 wherein fronts of the pull-out drawers constitute a door of the refrigerating unit.

6. The device according to claim 1 wherein the refrigerating unit is one of the following: a refrigerator, a fridge-freezer or a freezer.

7. (canceled)

8. The device according to claim 1 wherein the control panel is in communication with an external system that is one of following: a mobile application, a payment in cash or credit using a register system, external servers, or a combination thereof.

9. The device according to claim 1 further comprising a napkin dispensing mechanism to dispense napkins to the hot dog pick-up point.

10. The device according to claim 1 wherein the infrared radiator is one of following: a quartz radiator or a ceramic radiator.

11. The device according to claim 1 wherein the infrared radiator is mounted on a movable Z-axis.

12. The device according to claim 1 wherein the sauce application mechanism comprises from one to five sauce application nozzles.

13. A method for automatic preparation and dispensing of hot dogs by the device according to claim 1 comprising the following steps:
a) starting hot dog preparation process after product has been selected and paid for by a user through a control panel;
b) transmission of a signal to the controller initiating opening of the drawer of the refrigeration unit by the gripper moveable thought a griper rail and equipped with two pair of jaws movable by electric gripper drive;
c) picking up the food input and the bun from currently extended drawer of the refrigerating unit;
d) the gripper transporting the food input to the dedicated food input toaster and simultaneously the bun to the bun toaster;
e) the gripper dropping the food input on a dedicated toaster for food input and a bun on a bun toaster in toasting positions;
f) the food input being heated up by way of actuating rotating rollers with internal heaters of the toaster dedicated to the food input and lowering the infrared radiator, and toasting the bun using the heaters arranged around the plates of the bun toaster, which toaster is placed horizontally and then vertically during toasting of the bun, the heating of the food input and toasting of bun taking place simultaneously;
g) once the food input and the bun have reached a pre-set temperature, the heating elements of the dedicated food input toaster and the bun toaster are switched off,
h) positioning of at least one nozzle and application of the sauce through at least one application nozzle of the sauce application mechanism to the toasted bun located in the bun toaster which, during this operation, is in a vertical position;
i) aligning an axis of symmetry of the food input and the bun which are then situated in the toasters by returning the bun toaster to the horizontal position and inserting the food input into the bun by means of a movable pusher and cleaner, whereby the elements of the toaster dedicated to the food input are being cleaned;
j) lifting top lid of the bun toaster and having the hot dog picked up by the gripper;
k) having a napkin placed in hot dog pick-up area by napkin dispensing and delivery mechanism;
l) transferring the hot dog to the hot dog pick-up point;
m) dispensing the hot dog to customer from the hot dog pick-up point.

14. The method according to claim 13 wherein in step a) payment is made via the control panel either via a dedicated application or via cash register system of facility using the device.

15. The method according to claim 13 wherein the hot dog pick-up point constitutes a feeder equipped with vertically movable partitions.

16. The device according to claim 1 wherein the device includes an integral payment subsystem and the device is therefore standalone.
